(19) United States
(12) Patent Application Publication
(10) Pub. No.: US 2014/0026994 A1
(43) Pub. Date: Jan. 30, 2014

(54) FLUID SENSING AND DISTRIBUTING APPARATUS

(71) Applicant: Richard N. Codos, Warren, NJ (US)

(72) Inventor: Richard N. Codos, Warren, NJ (US)

(21) Appl. No.: 13/826,174

(22) Filed: Mar. 14, 2013

Related U.S. Application Data
(60) Provisional application No. 61/675,901, filed on Jul. 26, 2012.

(51) Int. Cl. F15B 13/07

(52) U.S. Cl. CPC F15B 13/07
USPC 137/625.11

(57) ABSTRACT

A fluid sensing and distributing apparatus having a distribution plate and an indexing plate is provided. The distribution plate may include a first distribution face and a second distribution face and a plurality of ports extending between the first distribution face and the second distribution face. The first distribution face may further contain a plurality of arc grooves. The indexing plate may have a first indexing face, a first group of ports in fluid communication with the distribution plate arc grooves, a second group of ports in fluid communication with the distribution plate ports, and a first group of ports in fluid communication with a second group of ports. The apparatus has a means for driving rotational movement between the indexing and distribution plates. The apparatus may further contain a plurality of ports on the distribution plate in direct fluid contact with an external apparatus matching plurality of ports.

### CROSS REFERENCE TO RELATED APPLICATION

The present application is based upon and hereby claims priority to U.S. Provisional Patent Application No. 61/675,901, filed Jul. 26, 2012, the content of which is hereby incorporated by reference in its entirety.

### BACKGROUND OF THE INVENTION

In many processes it is necessary to obtain a large number of fluid sampling measurements from a multitude of fluid ports as well as provide a large number of fluid distributions and deliveries to selective fluid ports. The standard approach has been to use a discrete number of fluid valves on the distribution side and the sampling side. In cases requiring sampling and distribution of multiple fluid channels, it has often be accomplished by using the required number of multi port valves that assign discrete sampling and distribution channels to each fluid port. As the number of distribution and sampling channels increases, the need for more and more valves introduces increasing costs associated with the large number of valves. Also, as the number of valves increases, so does the associated fluid piping and complexity associated with the valves. In addition, the greater the number of valves, the greater the associated power consumption, noise level, and increased valve space footprint. A significant shortcoming in stacking discrete valves is as the number of valves increases so does the corresponding valve footprint. Additionally, there is a relationship between valve size and the fluid flow rate or CV. The smaller the valve, the smaller the associated valve orifices and consequential flow rate. Many applications require a high fluid flow rate that requires a valve with large orifices and a large footprint. However, in many commercial product applications, valve space is limited. Additionally, as the valve size increases often the valve response time decreases.

Several apparatuses have been developed to create a single apparatus that can direct the fluid flow to multiple ports. Similarly, several apparatuses have been developed to sample the fluid flow from multiple ports in a single apparatus. For example, several internal and external barrel based sampling valves are known.

Cioffi, U.S. Pat. No. 3,814,129 describes a rotary sampling device that samples fluid from a number of ports. This apparatus employs a truncated conical barrel with an internal barrel plug that is in contiguous contact. Peripheral channels conduct and direct the fluid between the two barrels to external ports. In this apparatus the plug barrel is rotated to allow different channels to be in fluid contact with different conduits on the truncated conical barrel.

Rudenko, U.S. Pat. No. 4,263,937 describes a scanning valve for multi-point gas measurement that uses a hollow cylindrical internal cylinder described as a rotor with annular channels, and an external drum described as a stator with outlet ports arranged in the planes of the annular channels.

Both Cioffi and Rudenko sample only valves that are based on a cylinder inside a cylinder design. Such a design requires a high level of manufacturing tolerance between the cylinders in order to insure smooth cylinder on cylinder movement while maintaining a close tolerance that insures proper sealing between the two cylinder components. The scalability of these designs is considerably more complex as the number of sampling ports is increased. Manufacturers in the past have limited port numbers to a maximum of 64 ports per valve. Machining slots and ports into the cylindrical valve elements of these two apparatuses, while holding appropriate element tolerance between the two cylinders, becomes increasingly difficult as the size of the valve increases as more ports are incorporated. This is a limitation of cylinder inside cylinder designed fluid sampling apparatus.

Spencer, U.S. Pat. No. 5,261,451 describes a pneumatic multiplexer that samples a group of pneumatic ports. This apparatus features a rotor in a rotor housing that has a central tube in flow communication with a rotor channel that is in flow communication with a plurality of arc groves in the stator face. Although technically not a cylinder inside a cylinder design, the rotor in a rotor housing has many of the same tolerance and manufacturing issues associated with a cylinder in a cylinder apparatus. This apparatus is limited by its requirement that the rotor feeds a central tube thereby limiting the sampling of the valve to a single channel. Since the center of the rotor is dedicated to the central sampling channel the rotor drive element must be situated on the stator. As a result increasing the number of ports beyond the four illustrated is both technologically complex and impractical.

Morita et al., U.S. Pat. No. 5,478,475 describe a fluid distribution apparatus that incorporates processing chambers into a fluid distribution apparatus. Morita et al. attempt to solve the tubing complexity in a distribution system by incorporating the chambers where the fluid is directed into the apparatus structure. The apparatus is limited by a difficulty to scale the number of ports, as well as by its manufacturing complexity. An additional limitation occurs as ports are added to this apparatus because the apparatus must become larger in order to accommodate the additional ports.

Jensen et al., U.S. Pat. No. 7,191,797 describe a rotary distribution apparatus having cylinders inside cylinders with a porting scheme that increases the number of ports over prior cylinder apparatuses. This apparatus is complex and expensive to manufacture.

### SUMMARY OF THE INVENTION

The present invention provides a fluid sensing and distributing apparatus having a distribution plate and an indexing plate. In some instances, the distribution plate may include a first distribution face and a second distribution face that may be substantially parallel to the first distribution face, and a plurality of ports extending between the first distribution face and the second distribution face. The first distribution face may further contain a plurality of arc grooves. The indexing plate may have a first indexing face, a first group of ports in fluid communication with the distribution plate arc grooves, a second group of ports in fluid communication with the distribution plate ports, and a first group of ports in fluid communication with a second group of ports. The apparatus further has a means for driving rotational movement between the indexing and distribution plates. The apparatus may further contain a plurality of ports on the distribution plate in direct fluid contact with a matching plurality of ports in an external apparatus.

In other instances, the indexing plate may have a first indexing face, a first group of ports, a plurality of arc grooves in the first indexing face, and a first group of ports in fluid communication with a plurality of arc grooves. The distribution plate may include a first distribution face, a reverse distribution face, and a first group of ports and a second group of ports extending there between. The distribution plate may further have a first group of ports in fluid communication with the index plate arc grooves and a second group of ports in fluid communication with the index plate first group of ports. The apparatus further has a means for driving rotational movement between the indexing and distribution plates. The distribution plate may further have a plurality of ports in direct fluid contact with an external apparatus matching plurality of ports. The index plate arc grooves may be arranged in concentric rings.

The plurality of ports extending there between may be in fluid connection with a sensing device and in fluid connection with a fluid supply, for example, once every revolution. The distribution plate arc grooves may be arranged in one or more substantially concentric rings. Likewise, the distribution plate ports may be arranged in one or more substantially concentric port rings. Also, external fluid connections such as hose connectors may be made directly to the plurality of ports on the distribution plate.

There may be a third plate between the distribution plate and the index plate such as for instance, a slip plate. Also, a means for driving rotational movement between the indexing plate and the distribution plate such as, for instance, a motor may be supplied. In addition, an encoder may be provided. The distribution plate and the index plate may be housed in any suitable casing or enclosure.

### BRIEF DESCRIPTION OF THE DRAWINGS

FIG. 1 is a perspective view of the sensing and distributing apparatus according to the invention.

FIG. 2 is an expanded view of the sensing and distributing apparatus of FIG. 1.

FIG. 3A is a top perspective view of the distribution plate shown in FIG. 2 showing distribution channels, sensing channels, and distribution and sensing ports. FIG. 3B is a top perspective view of the distribution plate shown in FIG. 2 without distribution channels and sensing channels.

FIG. 4 is a bottom view of the distribution plate shown in FIG. 2 showing sensing and distribution ports.

FIG. 5 is a cross-sectional side view on line A-A of FIG. 3 showing the distribution and sensing channels.

FIG. 6A is a top view of the middle indexing plate of FIG. 1. FIG. 6B is a cross-sectional side view on line A-A. FIG. 6C is a cross-sectional side view on line B-B. FIG. 6D is a cross-sectional side view on line C-C. FIG. 6E is a top view of the middle indexing plate of FIG. 1 including sense and distribution channels.

FIG. 7 is a perspective top view of the slip plate of FIG. 1.

FIG. 8 is a flow diagram of a process incorporating the apparatus to illustrate the fluid distribution aspect of this apparatus.

FIG. 9 is a flow diagram of a process incorporating the apparatus to illustrate the sensing aspect of this apparatus.

FIG. 10 is a control block diagram demonstrating operation of the apparatus.

FIG. 11 is a fluid schematic diagram showing the fluid paths of the apparatus.

### DETAILED DESCRIPTION OF THE PREFERRED EMBODIMENTS

The present invention provides an apparatus that incorporates both multi-port fluid sensing as well as multi-port fluid distributing into a single apparatus. The fluid sensing and distributing apparatus provides a large number of ports, for example, 50, 75, 100, 125, 150, 200 or more, in a single apparatus. The apparatus may be scalable to provide more ports without significantly increasing the apparatus footprint or apparatus cost. The fluid distribution and sensing ports may be provided in concentric rings on a distribution plate. Additional ports may be provided on additional concentric rings of port holes at an increasing radius from the plate center. For example, in some instances the port may be a typical 0.125 inch port so that, for instance, an additional approximately 50 ports may be added by increasing the distribution plate radius by about 0.200 inch and providing about 50 concentrically drilled port holes. A corresponding sensing channel and distribution channel, along with associated matching port may be provided to an indexing plate. Additional ports may also be added to the existing concentric rings of port holes limited only by the port diameter and the requirement to maintain sealing space between port holes to provide adequate port to port sealing. For example, 50, 60, 70, 80, 90, 100, 125, 150 or more ports may be arranged in individual concentric ring of ports.

The apparatus may reduce the complexity of the fluid distribution and sensing network between the apparatus and an associated apparatus for which distribution and sampling are desirable. In one embodiment, a valve body is fastened directly into the apparatus base plate to eliminate any tubing interconnections between the apparatus and an associated apparatus. The apparatus achieves this objective by providing a flat distribution plate on which the inlet and output ports are located. This distribution plate allows for connection to the associated apparatus through a matching port plate on the apparatus side. Fluid connections are achieved by mating these two parts and using any of known means for ensuring a substantially leak-proof connection. In another embodiment, the distribution plate can be directly built into the associated apparatus thereby eliminating the need for a matching port plate and thereby reducing the complexity of the apparatus as combined with an associated apparatus.

The apparatus functions to maximize fluid distribution flow rates. The apparatus also minimizes fluid channel displaced volume when sensing pressure of a port. This is achieved by using fluid distribution channels that have a greater cross section than those of fluid sensing channels. The apparatus provides a fast response time for both the sensing and distribution ports by using a continuous mechanical drive system. In some embodiments, the apparatus uses a continuous velocity motor that rotates the indexing plate at, for instance, about 10, 20, 30, 40 or 50 rotations per minute (rpm), each port is either in a filling or sampling state for about 70, 60, 50, 40, 30, 20 or 10 or so milliseconds (ms) per revolution. The filling for a specific port may be performed at ½ revolution of the indexing plate apart of the sensing for the same port. As a result, the same port may be filled milliseconds, for instance 3000, 1500, 1000, 750, 600, 500 or so ms before and after the same port is sensed. In this embodiment about 150 ports are both filled and sampled every approximately 2 seconds when used with an about 30 rpm motor.

The apparatus may maintain the same cycle time per port even when the number of ports is increased. This may be achieved by adding ports, in concentric rings, to the existing ports, to the distribution plate. Regardless of how many rows of ports are provided on the distribution plate, the rpm of the indexing plate may be held constant. As more ports, in concentric rings, are added to the distribution plate, the cycle time per port may also remain unchanged despite having added more ports.

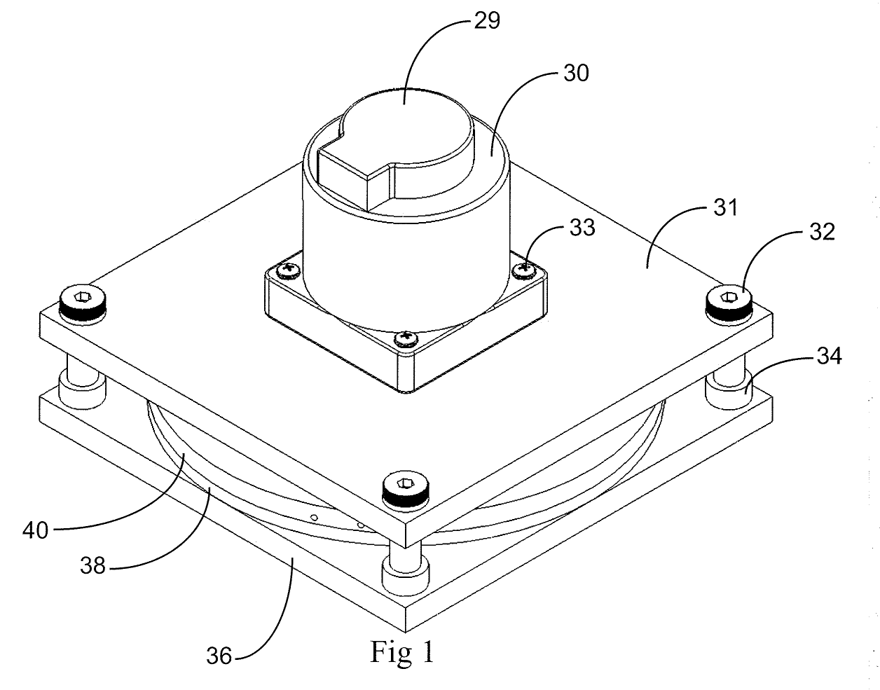

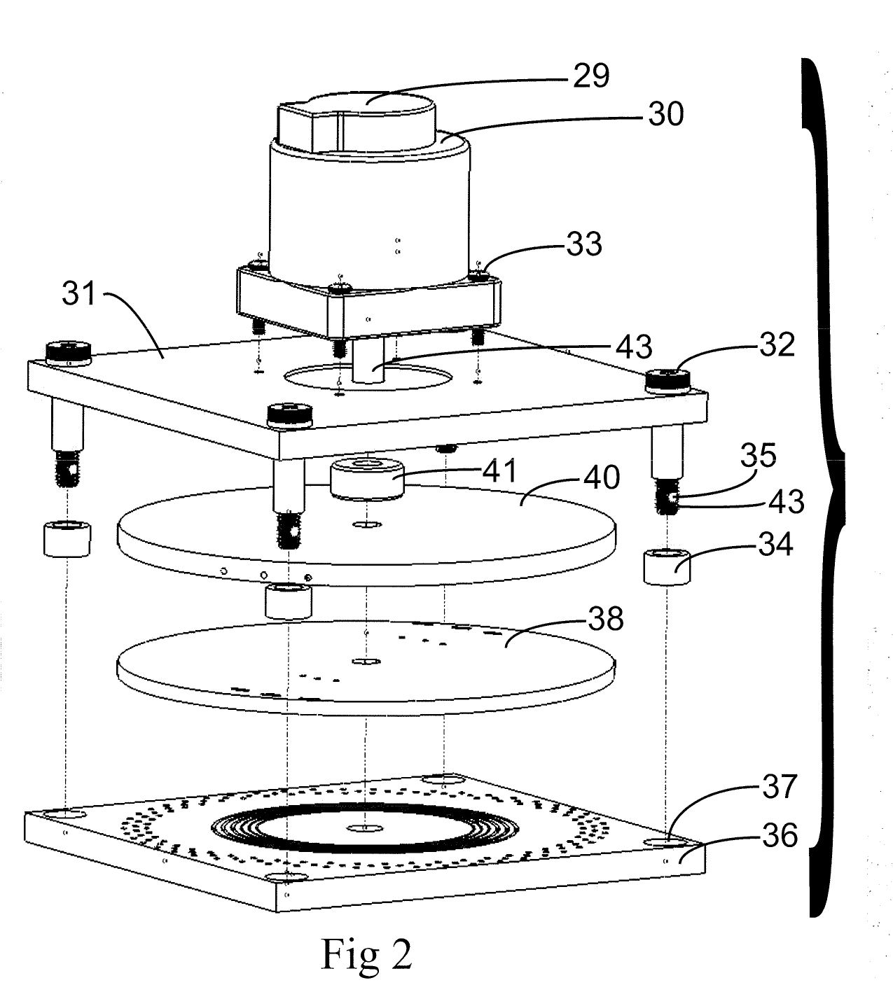

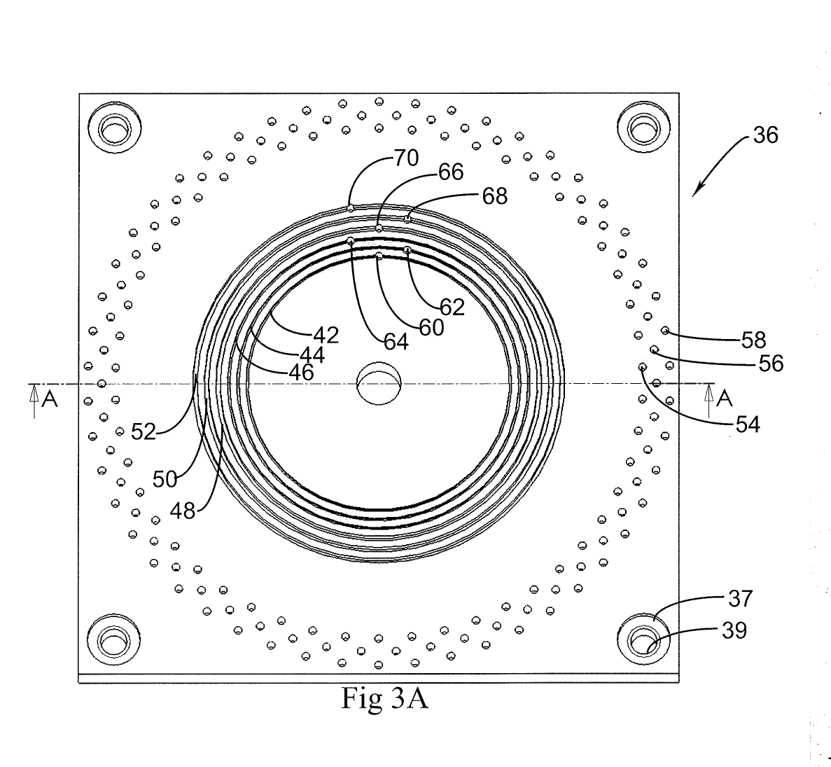

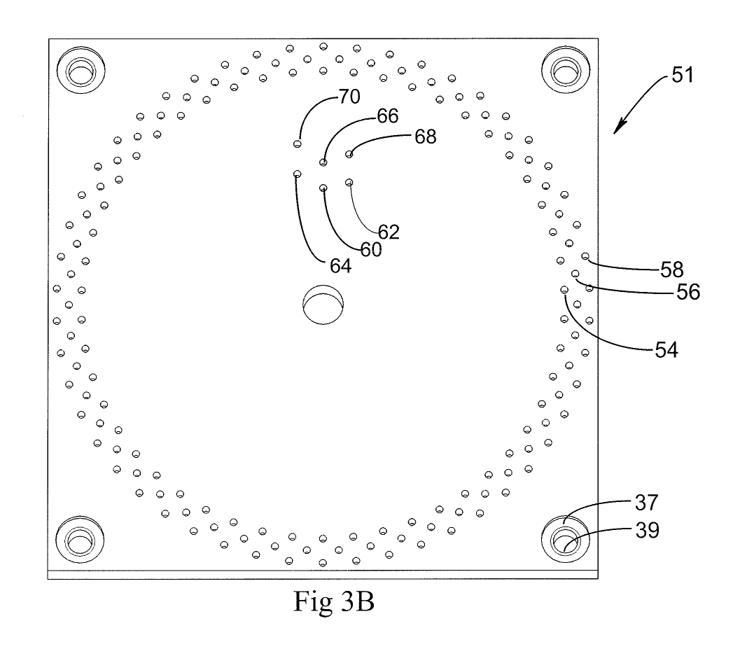

Referring to FIG. 1, a fluid sensing and distribution apparatus is shown that includes an encoder 29 that encompasses a single rotation zero position indicator. The encoder 29 is attached to the back end of a motor, 30. The encoder may in some instances be connected to the motor 30. In some instances the encoder may be attached to or obtain readings from one or more rotatable discs, an indexing plate 40, and a slip plate 38. In some instances, the readings may be performed by providing a read head on the apparatus construed to read spaced port holes 54, 56, 58 located in a port ring as shown in FIG. 3A. In some instances, the zero position indicator may not reside with the encoder 29, instead residing as a separate read head attached to the apparatus and reading a zero position marking situated on one of the rotatable discs, an indexing plate 40, and a slip plate 38. When the encoder 29 is attached to the back end of a motor 30, the motor 30 may be a step motor that operates in a constant velocity rotary mode. The motor 30 may be fastened to a motor plate 31 via a connecting means 33 such as screws. The motor 30 may be, for instance, a servo motor, an ac or dc synchronized motor, or an ac or dc non-synchronized motor. Alternative modes of rotational movement may take the form of, for instance, varying velocity rotary mode, indexing rotary motion mode, reciprocating rotary motion mode, or some combination of constant or varying velocity and indexing rotary motion modes per revolution. The term ‘revolution’ means any portion of a rotational movement up to 360 degrees. The motor shaft, 43 (FIG. 2), is in mechanical contact with the indexing plate 40, and the slip plate 38. The slip plate 38 seals the fluid connection between indexing plate 40 and distribution plate 36.

A mechanical fastener 32 and spacer 34 fasten the rotary motor plate 31 to the distribution plate 36. A mechanical fastener 32 may be a shoulder bolt with a self locking feature 35 (FIG. 2) on the threads. Spacer 34 may engage into a counter bored receptacle 37 (FIG. 2), on the distribution plate 36. This engagement between the shoulder bolt 35, the counter bore 37 on the distribution plate 36 insures that the motor plate 31 and the distribution plate 36 remain in vertical alignment.

Referring to FIG. 2, an expanded view of the sensing and distributing apparatus of FIG. 1 is provided. Thrust bearing 41 is situated between the indexing plate 40, and the motor plate 31. An axial load is applied between the motor plate 31 and the distribution plate 36 through the thrust bearing 41. A radial motion is applied from the motor 30, to the indexing plate 40 and the slip plate 38 through the thrust bearing. The thrust bearing 41 may be a one piece shielded unit or it may be a non-shielded multi-piece bearing, a spherical bearing, or other axial plus radial bearing component or assembly.

The axial load, applied perpendicular to the motor plate 31 may be increased by tightening the four mechanical fasteners 32 such as shoulder bolts. In order to maintain the motor plate 31 and distribution plate 36 parallel, each mechanical fastener 32 may be rotated substantially the same number of turns. A self locking pad 35 may insure that the mechanical fastener thread 43 does not disengage or change position relative to a threaded hole 39 (FIG. 3A) in the distribution plate 36.

Referring to FIG. 3B a perspective view of the side of the distribution plate 36 is provided. The distribution plate 36 has about 150 ports, for instance, 50, 100, 150, 200 or more, for both fluid sensing and distribution arranged in concentric rings of ports, for instance, 3 concentric rings, inner ring 54 having 50 identical ports, middle ring 56 having 50 identical ports, and outer ring 58 having 50 identical ports. The center-line distance between the outer ring 58 and middle ring 56 may be, for instance, about 0.1, 0.2, 0.3 or so inches. The center-line distance between the middle ring 56 and inner ring 54 may be, for instance, about 0.1, 0.15, 0.175, 0.185, 0.20 or 0.25 or so inches. Additional ports, for example, 50 or so additional ports may be added by adding a concentric port ring at a center-line distance of about, for instance, 0.2 inches out from the outer ring 58.

Three supply channels are provided. Distribution channel 70 in fluid communication with outer ring 58 through the indexing plate 40 (FIG. 2) and slip plate 38 (FIG. 2), middle supply channel 68 in fluid communication with middle ring 56 through the indexing plate 40 (FIG. 2) and the slip plate 38 (FIG. 2), and the inner distribution channel 66 that is in fluid communication with the inner ring 54 through the indexing plate 40 (FIG. 2) and the slip plate 38 (FIG. 2). Outer supply channel 52 is in fluid communication to an external fluid supply system through port 70. Middle supply channel 50 is in fluid communication to an external fluid supply system through port 68. Inner supply channel 48 is in fluid communication to an external fluid supply system through port 66.

Three sensing channels are provided. Outer sense channel 46 is in fluid communication with the outer ring 58 through the indexing plate 40 (FIG. 2) and the slip plate 38 (FIG. 2), middle sense channel 44 is in fluid communication with the middle ring 56 through the indexing plate 40 (FIG. 2) and the slip plate 38 (FIG. 2), and the inner sense channel 42 is in fluid communication with the inner ring 54 through the indexing plate 40 (FIG. 2) and the slip plate 38 (FIG. 2). Outer sense channel 46 is in fluid communication to an external sensing system through port 64. Middle sense channel 44 is in fluid communication to an external sensing system through port 62. Inner sense channel 42 is in fluid communication to an external sensing system through port 60.

Referring to FIG. 3B is a perspective view of the side of an alternative distribution plate 51 without sense and distribution channels. The distribution plate 51 has about 150 ports, for instance, 50, 100, 150, 200 or more, for both fluid sensing and distribution arranged in concentric rings of ports, for instance, 3 concentric rings, inner ring 54 having 50 identical ports, middle ring 56 having 50 identical ports, and outer ring 58 having 50 identical ports. The center-line distance between the outer ring 58 and middle ring 56 may be, for instance, about 0.1, 0.2, 0.3 or so inches. The center-line distance between the middle ring 56 and inner ring 54 may be, for instance, about 0.1, 0.15, 0.175, 0.185, 0.20 or 0.25 or so inches. Additional ports, for example, 50 or so additional ports may be added by adding a concentric port ring at a center-line distance of about, for instance, 0.2 inches out from the outer ring 58. Three supply channels are provided. Distribution channel 70 in fluid communication with outer ring 58 through the indexing plate 40 (FIG. 2) and slip plate 38 (FIG. 2), middle supply channel 68 in fluid communication with middle ring 56 through the indexing plate 40 (FIG. 2) and the slip plate 38 (FIG. 2), and the inner distribution channel 66 that is in fluid communication with the inner ring 54 through the indexing plate 40 (FIG. 2) and the slip plate 38 (FIG. 2).

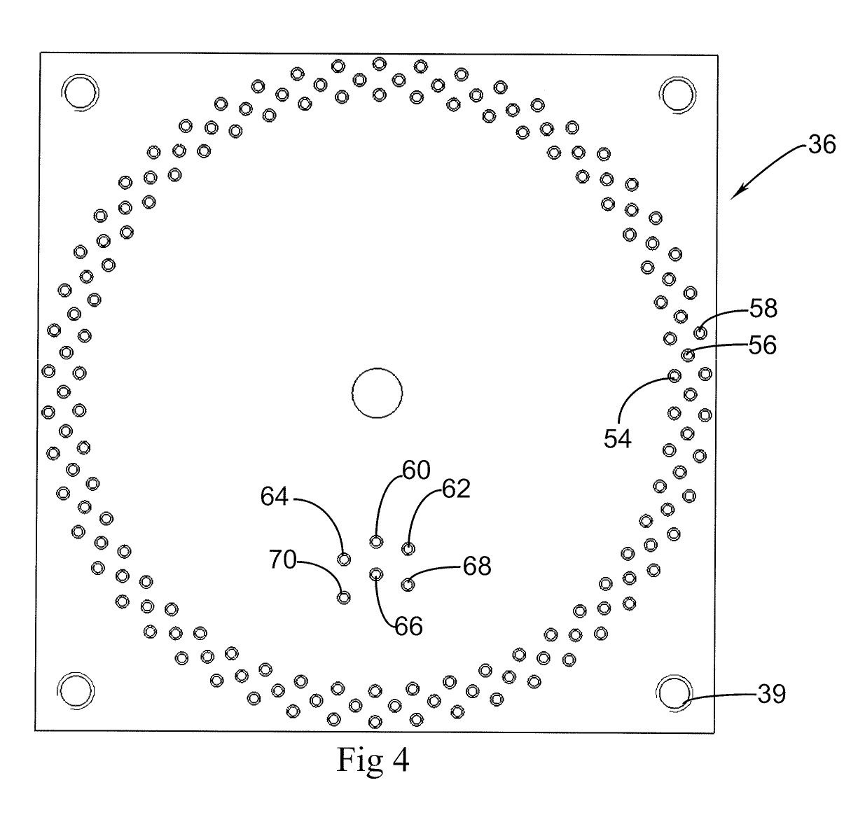

Referring to FIG. 4, the backside of the distribution plate 36 is shown. The backside is the parallel, but opposite, side shown in the FIG. 3A perspective. In some instances, all of the port holes shown in FIG. 4 are taped, for instance, with a 10-32 screw hole. Thereby, the backside of the distribution plate 36 may be used for connection to the associated apparatus through a matching port plate on the apparatus side, or a standalone distributing and sensing apparatus. Threaded barb connectors (for example, but not shown, a McMaster-Carr part #5454K62 brass barbed tube to 10-32 hole adapter) may be screwed into the backside of the distribution plate 36 for connection. In some instances, the apparatus may be configured for connection to an associated apparatus through a matching port plate on the apparatus side. This connection can be made by attaching the distribution plate 36 directly to the external apparatus matching port plate, insuring a port to port seal by a connecting means.

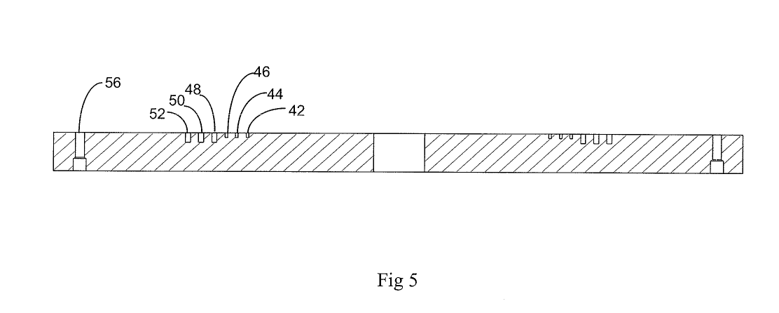

Referring to FIG. 5, a cross section side view on line A-A of FIG. 3A is shown depicting the distribution and sensing channels. Distribution channels 52, 50, and 48 are shown to have a larger cross-sectional area than sensing channels 46, 44, and 42. In some instances, the supply channels have a width of about 0.125 inches and a depth of about 0.125 inches for a cross-section area of about 0.0156 inches. Furthermore, the sensor channels may have a width of about 0.0625 inches and a depth of about 0.0625 inches for a cross-sectional area of about 0.0039 inches. A distribution channel higher cross-sectional area is consistent with maximizing the distribution side flow, or CV of the apparatus. The smaller cross-sectional area of the sensing channels is provided to minimize fluid losses during sampling intervals. If a higher flow rate is needed, an increase in the depth of the distribution channel will result in a higher distribution flow rate.

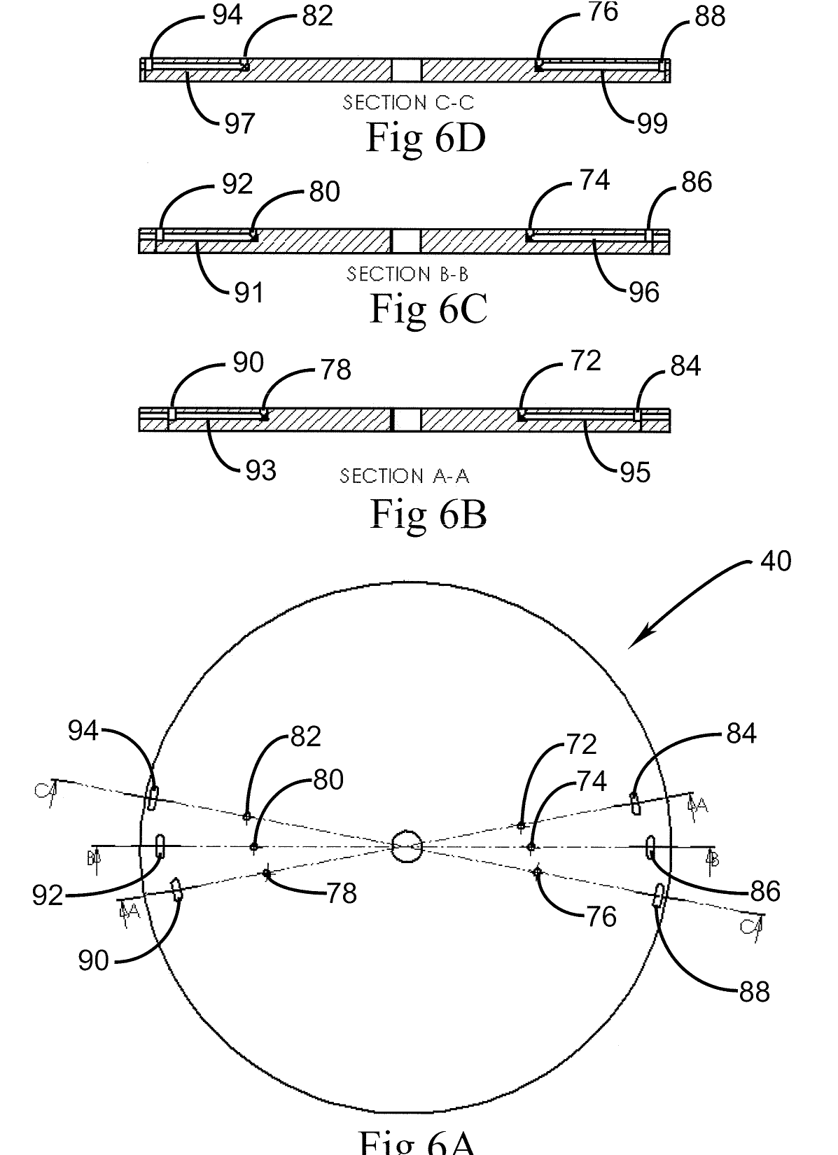

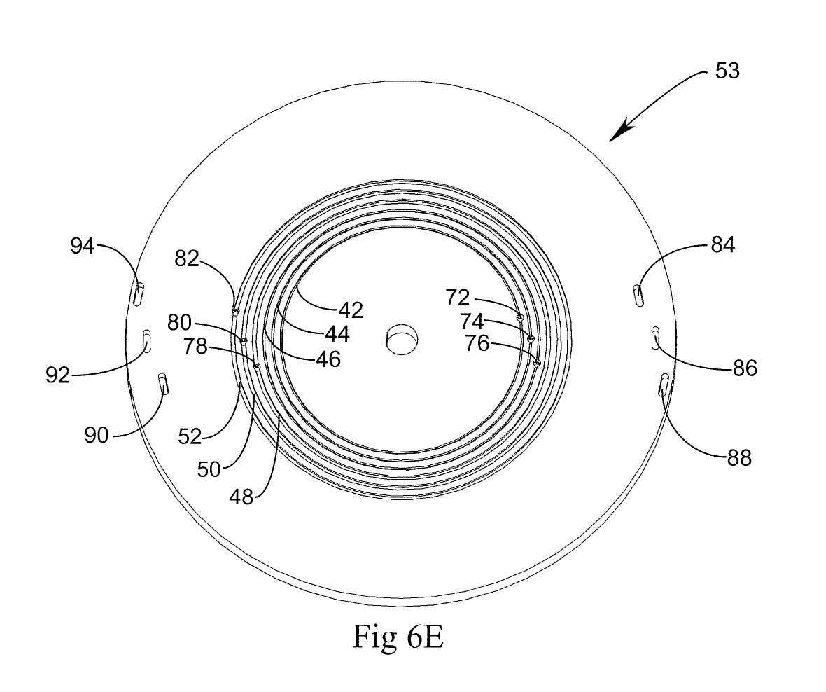

Referring to FIG. 6A, a top view of the indexing plate 40 is provided. The index plate is coupled to the slip plate 38 by a bonding adhesive adhered to the slip plate 38. Fluid channels in the index plate couple the distribution channels 66, 68, and 70 of the distribution plate 36 with their respective fluid port rings 58, 56, and 54 of the distribution plate 36 (FIG. 4). Outer port ring supply slot 94 is connected to outer fluid supply channel port hole 82 by distribution channel 97 (FIG. 6D). Inner port ring supply slot 90 is connected to inner fluid supply channel port hole 78 by distribution channel 93 (FIG. 6B). Outer port ring sense slot 88 is connected to outer fluid sense channel port hole 76 by sense channel 99 (FIG. 6D). Middle port ring sense slot 86 is connected to middle fluid sense channel port hole 74 by sense channel 96 (FIG. 6C). Inner port ring sense slot 84 is connected to inner fluid sense channel port hole 72 by sense channel 95 (FIG. 6B). The leading edge of outer port ring supply slot 94 is in contact with the trailing edge of a port hole in outer ring 58 (FIG. 3A) at the same time that the leading edge of middle port ring supply slot 92 is in contact with the trailing edge of a port hole in middle ring 56 (FIG. 3A) at the same time that the leading edge of inner port ring supply slot 90 is in contact with the trailing edge of a port hole in inner ring 54 (FIG. 3A). Additionally, the leading edge of outer port ring sense slot 88 is in contact with the trailing edge of a port hole in outer ring 58 (FIG. 3A) at the same time that the leading edge of middle port ring sense slot 86 is in contact with the trailing edge of a port hole in middle ring 56 (FIG. 3A) at the same time that the leading edge of inner port ring sense slot 84 is in contact with the trailing edge of a port hole in inner ring 54 (FIG. 3A). All slots 84, 86, 88, 90, 92, and 94 contact the trailing edge of their respective port holes at the same time. Outer port ring supply slot 94 is about 180 degrees displaced from outer port ring sense slot 88, middle port ring supply slot 92 is about 180 degrees displaced from middle port ring sense slot 86, and inner port ring supply slot 90 is about 180 degrees displaced from inner port ring sense slot 84. Other modifications to the above embodiment will readily appear to those who are skilled in the art. Such modifications may include, for instance, changing the location of supply and sense slots positions relative to each other. Any relative offset between the sense and supply slots on a corresponding port ring is acceptable as long as the sense and supply slots do not sample and supply the same port at the same time. In some instances, distribution channels 97, 91 and 93, as well as sense channels 99, 96, and 95 are tangentially drilled normal to the plate surface of FIG. 6A to connect their respective port holes with their respective channels. The drilled hole may be plugged at the surface, by a screw plug not shown. The drilled channels may be replaced with a milled slot that may be sealed by the bonded slip plate 38 (FIG. 2). The arc grooves 42, 44, 46, 60, 62, 64 (FIG. 3A) may be relocated onto the indexing plate 40 from the distribution plate 36 (FIG. 2).

Referring to FIG. 6E is an alternative embodiment of the index plate 53 that includes the elements described for index plate 40 of FIG. 6A along with sense and distribution channels. Sense channels 42, 44 and 46 are provided along with distribution channels 48, 50 and 52. Supply channel port holes 72, 74 and 76 are also provided.

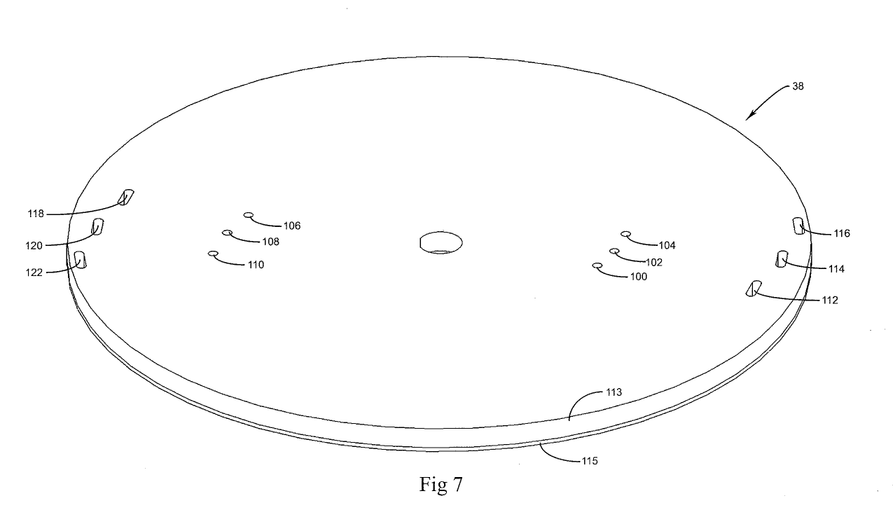

Referring to FIG. 7, the slip plate 38 may be a laminated construction made of, for instance, a proprietary polytetrafluoroethylene (PTFE) compound trade named Rulon film 115. It may be, for instance, about 0.01, 0.02, 0.03 or so inches thick. The film may also be made of an acetal homopolymer, UHMW polyethylene, filled PTFE, or another fluoropolymer which all exhibit good degrees of slickness while maintaining both the toughness and chemical resistance to act as a good fluid sealing layer. The film may be bonded via a silicone adhesive to a quick recovery super-resilient polyurethane foam 113. The polyurethane foam may have a firmness measured as about 8-14 psi resulting in about 25% compression of the foam. The super-resilient polyurethane foam 113 may be another compressible material such as EPDM foam, neoprene foam, natural gum foam or synthetic or natural rubber that is compressible. In such instances, the foam 113 may be bonded via a silicone adhesive to the indexing plate 40 (FIG. 1). For instance, a non laminated material such as a porous PTFE is both slippery and compressible and may be used in place of the laminated structure. One function of the slip plate 38 is to provide fluid channel sealing between the indexing plate 40 and the distribution plate 36 while allowing rotational movement between the indexing plate 40 and the distribution plate 36. In some instances, the slip plate 38 may be incorporated into the indexing plate 40, or the distribution plate 36, or both, by embedding a slippery surface material into the aforementioned plates. One means for doing so is by sintering PTFE into the face of either the distribution or indexing plates. Additionally, in some instances the indexing plate 40, distribution plate 36, or both may be constructed from a suitable material that eliminates the need for a separate slip plate. In some such instances, the plate may be made from a rigid engineered thermoplastic such as acetal that has a high level of both rigidity and a low coefficient of friction giving it a slippery face.

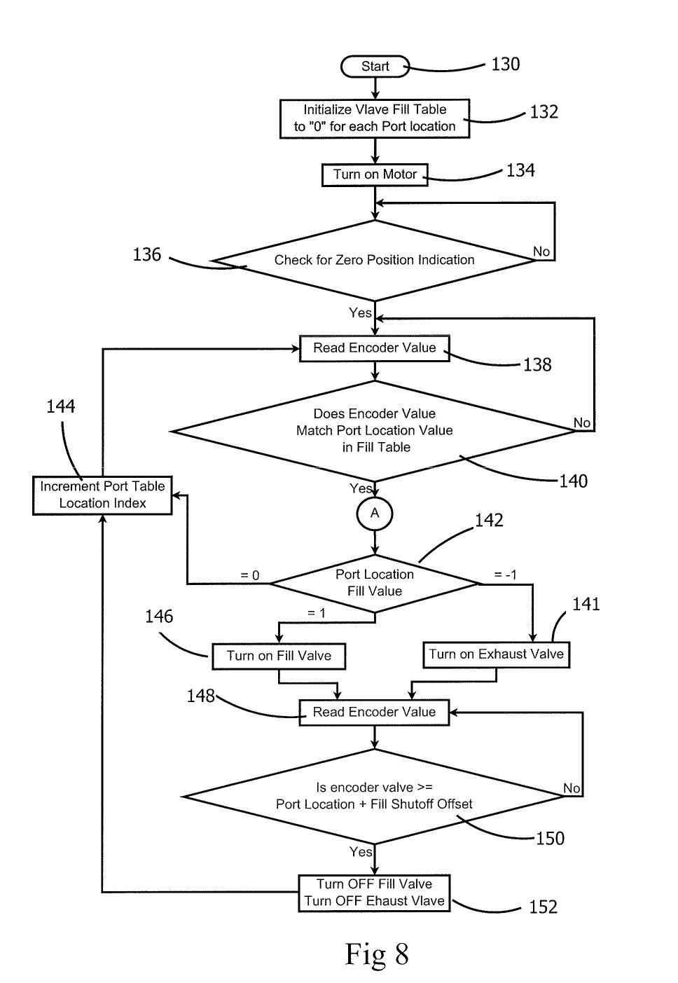

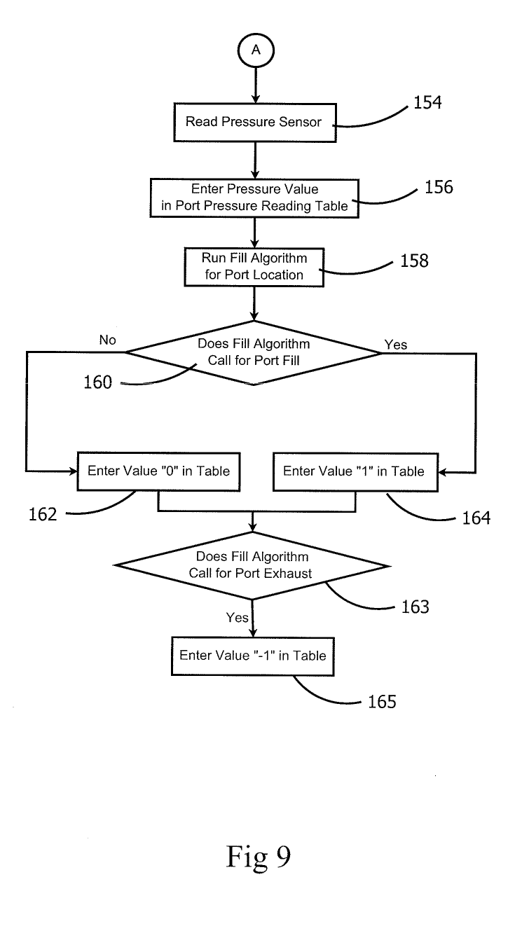

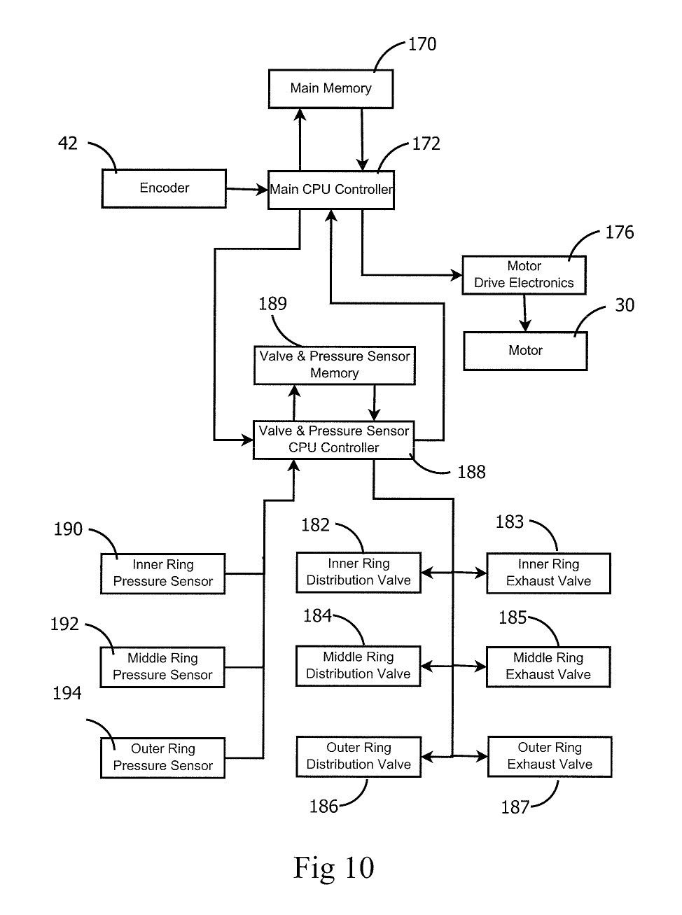

The present invention also provides methods for operating or controlling the apparatus as well as methods for sensing and delivering fluid, especially to a second apparatus. Referring to FIGS. 8-9, flow charts depicting the control sequence of the apparatus are provided. Referring to FIG. 10, a control diagram depicting the control sequence of the apparatus is provided. The apparatus is started in step 130 and is placed into an initial state in which the fill table which is located in memory 189, is initialized by the controller 172 in step 132 and set to an initial state where each port location in the fill table is initialized with a value of zero corresponding to no fill and no exhaust. The controller 172 then turns on the motor 30 in step 134. The controller 172 polls in step 136 the encoder 29, which incorporates a single turn zero position indicator, waiting for the zero position indicator to poll positive for a zero position location. Once the zero indication is positive, the controller 188 reads the encoder value in step 138, and the encoder value for zero position is stored in memory 189. The first fill port location is a known number of encoder counts offset from the zero position of the apparatus. As the motor continues to turn the indexing plate 40 (FIG. 1) the controller 188 continues to read the encoder value in step 138 comparing this value in step 140 until it matches the port location value in the fill table which is located in memory 189. The sensor ports may be about or even exactly 180° offset from the fill ports on the same encoder boundary position. Once the encoder 29 position matches the port location in step 140, the controller 188 checks the fill table located in memory 189 to see if this port location is calling for a distribution of fluid into the port as designated by the table having a value of “1” in the table port location. If a value of “1” is present indicating that filling the bladder is necessary, than the controller 188 sends a command in step 146 to turn on the appropriate valve, either 182, 184, or 186. If a value of “−1” is present indicating that exhausting air from the bladder is necessary, than the controller 188 sends a command in step 141 to turn on the appropriate valve, either 183, 185, or 187. If the fill table held a value of “0” indicating no fill is required, then the controller 188 increments the port table location index located in memory 189 in step 144 and returns to step 138 where it reads the encoder value from encoder 29.

At the same time the controller 188 is performing the above fill table analysis in step 142, it also gets a pressure reading from the appropriate pressure sensor 190, 192, or 194 from the pressure sensors in step 156. Once the pressure reading is complete the controller 188 enters the pressure reading into a fill algorithm in step 158 to determine if a fill or exhaust is required for the associated port that was just sampled. If the algorithm of step 160 indicates a fill, then the controller 188 inserts a value of “1” into the fill table that resides in memory 189 for the port just sampled in step 164. If the algorithm of step 160 does not call for a fill then the controller 188 inserts a value of “0” into the fill table that resides in memory 189 for the port just sampled in step 164. If the algorithm of step 163 indicates an exhaust is required then the controller 188 inserts a value of “−1” into the fill table that resides in memory 189 for the port just sampled in step 165.

After the controller 188 sends the valves control a command in steps 146 or step 141, it then reads encoder 29 in step 148. The controller continues to re-sample the encoder in step 148 until the returned encoder value is greater than or equal to the port location plus a stored, in memory 189, offset number that coincides with the back end of the port ring sense slot 84 (FIG. 6A) in step 150. Once the returned encoder value is greater than or equal to the port location plus a stored, in memory 189, offset number then the controller 188 turns off the respective valve, either 182, 184, 186, 183, 185, or 187. The controller 188 then increments the port table location index located in memory 189 in step 144 and returns to step 138 where it reads the encoder value from encoder 29, and the entire process starts to loop again in step 138.

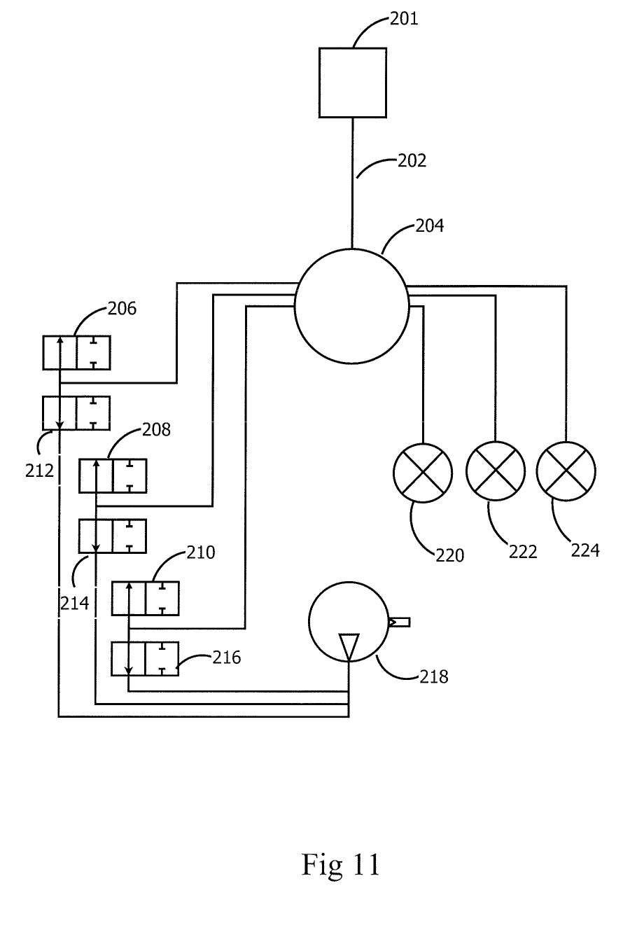

Referring to FIG. 11, a fluid schematic diagram showing the fluid paths of the apparatus is provided. An outside apparatus, object or device (such as a bladder disclosed in Codos, “A Pressure Adjustable Platform System,” copending U.S. application Ser. No. 61/675,496, filed Jul. 25, 2012) 201 is connected to the apparatus 204 via a single fluid channel 202. The bladder 201 will be connected to one of the distribution and sensing rings (inner, middle, or outer) depending on which port ring (inner, middle, or outer) it is connected to. In this embodiment valves 206, 208, 210, 212, 214, and 216 are pneumatic valves that connect to an air compressor 218. Valve 212 is a supply valve that connects to the outer supply channel 52 (FIG. 3A) and is in fluid communication with compressor 218 through port FIG. 3 70. Valve 206 is an exhaust valve that connects to the outer supply channel 52 (FIG. 3A) and is in fluid communication with the atmosphere. Valve 214 is a supply valve that connects to the middle supply channel 50 (FIG. 3A) and is in fluid communication with compressor 218 through port FIG. 3 68. Valve 208 is an exhaust valve that connects to the middle supply channel 50 (FIG. 3A) and is in fluid communication with the atmosphere. Valve 216 is a supply valve that connects to the inner supply channel 48 (FIG. 3A) and is in fluid communication with compressor 218 through port 66 (FIG. 3A). Valve 210 is an exhaust valve that connects to the inner supply channel 48 (FIG. 3A) and is in fluid communication with the atmosphere. Pressure sensor 224 is in fluid connection with the outer sense channel 46 (FIG. 3A) through port 64 (FIG. 3A). Pressure sensor 222 is in fluid connection with the middle sense channel 44 (FIG. 3A) through port 62 (FIG. 3A). Pressure sensor 220 is in fluid connection with the inner sense channel 42 (FIG. 3A) through port 60 (FIG. 3A).

The detailed description is representative of one or more embodiments of the invention, and additional modifications and additions to these embodiments may be readily apparent to those skilled in the art. Such modifications and additions are intended to be included within the scope of the claims. A person skilled in the art may make many variations, combinations and modifications without departing from the spirit and scope of the invention.

1. A fluid sensing and distributing apparatus comprising:
a distribution plate having a first distribution face having a plurality of arc grooves and a second distribution face, wherein a plurality of ports extends between the first distribution face and the second distribution face;
an indexing plate having a first indexing face, wherein the indexing plate contains a first group of ports in fluid communication with one or more of the arc grooves on the distribution plate and a second group of ports in fluid communication with one or more ports present on the distribution plate, and a first group of ports in fluid communication with second group of ports; and
a means for driving rotational movement between the indexing plate and the distribution plate.

2. A fluid sensing and distributing apparatus according to claim 1 further comprising a plurality of ports on the distribution plate in direct fluid contact with a plurality of ports in an external apparatus.

3. A fluid sensing and distributing apparatus according to claim 1, wherein the arc grooves are arranged in one or more substantially concentric rings.

4. A fluid sensing and distributing according to claim 1 wherein the ports on the distribution plate are arranged in one or more substantially concentric rings.

5. A fluid sensing and distributing apparatus according to claim 1 wherein external fluid connections are made directly to the plurality of ports on the distribution plate.

6. A fluid sensing and distributing apparatus according to claim 5, wherein the external fluid connections are hose connectors.

7. A fluid sensing and distributing apparatus comprising:
an indexing plate having a first indexing face having a first group of ports and a plurality of arc grooves thereon, wherein the first group of ports is in fluid communication with the plurality of arc grooves;
a distribution plate having a first distribution face and a second distribution face, wherein a first group of ports and a second group of ports extend between the first distribution face and the second distribution face, wherein the first group of ports is in fluid communication with the index plate arc grooves and the second group of ports is in fluid communication with the first group of ports on the indexing plate; and
a means for driving rotational movement between the indexing plate and the distribution plate.

8. A fluid sensing and distributing apparatus according to claim 7 further comprising a plurality of ports on the distribution plate in direct fluid contact with a plurality of ports in an external apparatus.

9. A fluid sensing and distributing apparatus according to claim 7, wherein the arc grooves are arranged in one or more substantially concentric rings.

10. A fluid sensing and distributing according to claim 7 wherein the ports on the distribution plate are arranged in one or more substantially concentric rings.

11. A fluid sensing and distributing apparatus according to claim 7 wherein external fluid connections are made directly to the plurality of ports on the distribution plate.

12. A fluid sensing and distributing apparatus according to claim 11 wherein the external fluid connections are hose connectors.

13. A fluid sensing and distributing apparatus comprising:
a distribution plate having a first distribution face and a second distribution face, a plurality of ports extending between the first distribution face and the second distribution face, a plurality of arc grooves in the first distribution face, wherein the plurality of ports are in fluid connection with a sensing device and in fluid connection with a fluid supply at least once per revolution of the indexing plate;
an indexing plate having a first indexing face having a first group of ports in fluid communication with the plurality of arc grooves in the first distribution face and a second group of ports in fluid communication with the plurality of ports on the distribution plate, wherein the first group of ports is in fluid communication with a second group of ports; and
a means for driving rotational movement between the indexing plate and the distribution plate.

14. A fluid sensing and distributing apparatus according to claim 13, wherein the arc grooves are arranged in one or more substantially concentric rings.

15. A fluid sensing and distributing apparatus according to claim 13 wherein the ports on the distribution plate are arranged in one or more substantially concentric rings.

16. A fluid sensing and distributing apparatus according to claim 13 wherein external fluid connections are made directly to the plurality of ports on the distribution plate.

17. A fluid sensing and distributing apparatus according to claim 16 wherein the external fluid connections are hose connectors.

18. A fluid sensing and distributing apparatus according to claim 13 further comprising a plurality of ports on the distribution plate in direct fluid contact with a plurality of ports in an external apparatus.

19. A fluid sensing and distributing apparatus comprising:
an indexing plate having a first indexing face having a first group of ports and a plurality of arc grooves thereon, wherein the first group of ports is in fluid communication with the plurality of arc grooves;
a distribution plate having a first distribution face and a second distribution face, wherein a first group of ports and a second group of ports extend between the first distribution face and the second distribution face, wherein the first group of ports is in fluid communication with the index plate arc grooves and the second group of ports is in fluid communication with the first group of ports on the indexing plate, wherein the plurality of ports are in fluid connection with a sensing device and in fluid connection with a fluid supply at least once per revolution of the indexing plate; and
a means for driving rotational movement between the indexing plate and the distribution plate.

20. A fluid sensing and distributing apparatus according to claim 19 further comprising a plurality of ports on the distribution plate in direct fluid contact with a plurality of ports in an external apparatus.

21. A fluid sensing and distributing apparatus according to claim 19, wherein the arc grooves are arranged in one or more substantially concentric rings.

22. A fluid sensing and distributing according to claim 19 wherein the ports on the distribution plate are arranged in one or more substantially concentric rings.

23. A fluid sensing and distributing apparatus according to claim 19 wherein external fluid connections are made directly to the plurality of ports on the distribution plate.

24. A fluid sensing and distributing apparatus according to claim 23 wherein the external fluid connections are hose connectors.
